(19) United States
(12) Patent Application Publication
(10) Pub. No.: US 2012/0071290 A1
(43) Pub. Date: Mar. 22, 2012

(54) MULTISTAGE TRANSMISSION

(76) Inventor: Donghwan Byun, Seoul (KR)

(21) Appl. No.: 13/322,561

(22) PCT Filed: May 26, 2010
(86) PCT No.: PCT/KR2010/003345

§ 371 Date: Nov. 26, 2011

(30) Foreign Application Priority Data
May 26, 2009 (KR) 10-2009-0046217
Jul. 14, 2009 (KR) 10-2009-0063885

(51) Int. Cl. F16H 3/62

(52) U.S. Cl. 475/288

(57) ABSTRACT

The present invention relates to a multistage transmission, comprising: a center shaft arranged in a frame such that the center shaft does not rotate; an input member arranged coaxially to the center shaft such that the input member is rotatable; a hub arranged coaxially to the center shaft such that the hub is rotatable; an epicyclic gear set which is coupled to the input member and mounted on the hub, and which is arranged coaxially to the center shaft such that the epicyclic gear set is rotatable, and which has at least two pairs of epicyclic gears, wherein each of the epicyclic gears has a sun gear, a ring gear, a satellite carrier and a pinion; an axial clutch which is involved in the operation of the sun gear which is selectively coupled to or separated from at least one of the peripheral members; a clutch assembly in which at least one of the clutches in a rotating direction are arranged in correspondence with the respective sun gears, wherein said clutches in the rotating direction are involved in the operation of the sun gear which is selectively coupled to or separated from the center shaft; and a transmission shaft which has a hollow portion and a plurality of radial through-holes, and which covers the center shaft and rotates to select a rotating direction, and which is involved in the operation of the clutch assembly. The multistage transmission of the present invention provides two or more gear ratios between the input member and the hub in accordance with the rotating direction of the transmission shaft.

### TECHNICAL FIELD

The present invention relates to an epicyclic gear-type multistage transmission.

### BACKGROUND ART

Many exemplary embodiments of a multistage transmission which is used in daily life and industrial field are known. For example, a plurality of sprockets is overlapped to be installed in a rear wheel hub and crank to be coupled by a chain and a transmission stage is selected by a derailleur. Such transmission may realize 27 gear ratios. However, such gear ratio may overlap or transmission from one stage to another stage is not performed at a consistent ratio.

As another form of transmission, an epicyclic gear-type hub transmission which has an epicyclic gear installed in a hub and controls a rotation of a sun gear to couple or decouple the sub gear and a center shaft is provided.

There is a transmission which has 8 gear ratios and forms a ratchet pawl in a sun gear and forms a coupling groove in a center shaft to be coupled with the pawl to thereby control the operation of the pawl coupled to or separated from the coupling groove. This type of transmission has complicated and numerous transmission shaft and peripheral parts, which is difficult to manufacture and has inconsistent acceleration ratio among transmission stages.

There is a transmission which has 14 gear ratios and mounts a pawl in an external circumference of a center shaft, mounts a transmission shaft having a cam surface in a hollow portion of the center shaft, forms a coupling groove in an internal circumference of a sun gear to be coupled to the pawl so that the pawl stands or lies down along the cam surface to be coupled to or separated from the sun gear. This type of transmission increases the number of transmission stages by inserting the transmission shaft into the center shaft and rotating the transmission shaft twice.

### DISCLOSURE

### Technical Problem

The present invention has been made to solve the problems and it is an object of the present invention to provide an epicyclic gear-type multistage transmission which efficiently includes various transmission stages and has a small structure and a light weight.

It is another object of the present invention to provide a multistage transmission which enables a quick transmission without cutting off or bypassing power for such transmission even while driving or suspension and has each transmission stage converted into a next stage at a same gear ratio.

### Technical Solution

In order to achieve the object of the present invention, a multistage transmission comprises a center shaft arranged in a frame such that the center shaft does not rotate; an input member arranged coaxially with the center shaft such that the input member is rotatable; an epicyclic gear set which is coupled to the input member and mounted on the hub, and which is arranged coaxially with the center shaft such that the epicyclic gear set is rotatable, and which has at least two pairs of epicyclic gears 1, 2, 3 and 4 which are arranged in parallel to each other, wherein each of the epicyclic gears has sun gears 11, 21, 31 and 41, ring gears 14, 24, 34 and 44, carriers 13, 23, 33 and 43, and pinions 12, 22, 32 and 42, and wherein the ring gears and the carriers of said two adjacent pairs of epicyclic gears cross each other and are coupled together so as to be prevented from rotating; a clutch assembly which is involved in the operation of each of the sun gears which is selectively coupled to and separated from the ring gear, the carrier, the pinion, the sun gear adjacent thereto and/or the center shaft; a transmission shaft which is arranged coaxially with the center shaft to select a rotating direction with respect to the center shaft, and which is involved in the operation of the clutch assembly; and a hub arranged coaxially with the center shaft such that the hub is rotatable, and the multistage transmission providing gear ratios of stage 3 or more between the input member and the hub in accordance with the rotating direction of the transmission shaft.

The multistage transmission couples the pair of epicyclic gears to another epicyclic gear to provide gear ratios of stage 6, stage 9, stage 12, stage 18 or more based on the pair of epicyclic gears providing a gear ratio of stage 3 with a combination of two pairs of epicyclic gears.

The epicyclic gear set of the multistage transmission according to claim 2 has a plurality of sun gears arranged at a distance in an axial direction to be selectively coupled to the center shaft by a plurality of concave coupling surfaces, and a guide slit formed in a main surface of the center shaft and selectively coupled to the sun gear, a plurality of pawls supported by the guide slit and coupled to or separated from the sung gear and a plurality of transmission shaft through holes formed in a main surface of the transmission shaft with respect to claim 1.

The concave coupling surfaces of the sun gear operate as ratchet in cooperation with the pawl.

The pair of epicyclic gears of the multistage transmission according to claim 3 have two pairs of epicyclic gears arranged in parallel in the center shaft to rotate, and has one of two sun gears of the pair of the epicyclic gears coupled to the center shaft not to rotate and the other one of the sun gears rotate freely to be connected by a gear ratio of 1 or less and a gear ratio of 1 or more, and couples the two sun gears to rotate all together or couples one of the sun gear and the carrier to rotate all together and concurrently rotates the other one of the sun gears freely to ensure a 1:1 connection and provides a gear ratio of stage 3 between the input carrier and the output carrier of the pair of epicyclic gears with respect to claim 1.

The epicyclic gear in which a rotation is input to the pair of epicyclic gears is called an input side and the epicyclic gear from which a rotation is output is called an output side. If the input sun gear is coupled to the center shaft, the input pinion rotates together with the input carrier transmits a rotation at a gear ratio of 1 or more faster than the number of rotations input to the input ring gear coupled to the output carrier, and upon coupling the output sun gear to the center shaft, transmits the rotation at a gear ratio of 1 or less slower than the number of rotations input to the output carrier. As the epicyclic gear operates integrally by the coupling of two of four elements, the input side and the output side rotate if the sun gear is coupled to the carrier, pinion or ring gear. If the two sun gears of the pair of epicyclic gears are coupled in an axial direction for rotation, the input side and the output side rotate.

One of the carriers of the pair of epicyclic gears of the multistage transmission according to claim 4 is coupled to a third epicyclic gear, ensures a gear ratio of stage 2 of a direction connection with one of a gear ratio of 1 or less and a gear ratio of 1 or more to provide a gear ratio of stage 6 between the input member and the output member with respect to claim 3.

In this case, the pair of epicyclic gears having a gear ratio of stage 3 is connected to a gear ratio of stage 2 in series to provide a gear ratio of 3×2, i.e., stage 6. The elements of the epicyclic gear which is coupled to the carrier may include the ring gear, the carrier or sun gear, and one of the two elements which are not coupled to the carrier may operate as the input side or output side.

If the input member includes the input carrier, the output member includes a third epicyclic gear. If the input member includes a third epicyclic gear, the output member includes the output carrier.

The epicyclic gear set of the multistage transmission according to claim 5 has four pairs of epicyclic gears arranged in parallel to the center shaft to rotate, couples a pair of epicyclic gears 2 and 3 in a center to respective carriers 23 and 33 not to rotate and has two pairs of epicyclic gears 1 and 2 and 3 and 4 in an outside form a pair of epicyclic gears, respectively to provide a gear ratio of stage 9 between the input member and the output member with respect to claim 1.

Each of the pair of epicyclic gears of the multistage transmission according to claim 6 couples one of the two sun gears to the center shaft not to rotate and rotates the other one of the two sun gears freely to connect a gear ratio of 1 or less and a gear ratio of 1 or more, couples the two sun gears to rotate all together or couples one of the sun gears and the carrier to rotate all together and concurrently rotates the other one of the sun gears for 1:1 connection and selects a gear ratio of stage 3 to provide a gear ratio of stage 9 by a combination of the two pairs of epicyclic gears with respect to claim 5.

If two transmissions with stage 3 are connected in series and having the different number of gear tooth (refer to exemplary embodiments), a gear ratio of stage 9, 3×3, may be provided.

One of the outside carriers of the pair of epicyclic gears of the multistage transmission according to claim 7 is coupled to a fifth epicyclic gear, and ensures a gear ratio of stage 2 of a direction connection with one of a gear ratio of 1 or less and a gear ratio of 1 or more to provide a gear ratio of stage 18 between the input member and the output member with respect to claim 5.

If the fifth epicyclic gear is coupled to the pair of input epicyclic gears, the input member may be the sun gear, carrier or ring gear of the fifth epicyclic gear. The element of the fifth epicyclic gear coupled to the carrier of the input epicyclic gear may be the sun gear, carrier or ring gear. The output member is the output carrier of the second pair of epicyclic gears. If the fifth epicyclic gear is coupled to the pair of output epicyclic gears, the input member may be the input carrier of the pair of first epicyclic gears and the output member may be the sun gear, carrier or ring gear of the fifth epicyclic gear. The element of the fifth epicyclic gear coupled to the carrier of the input epicyclic gear may be the sun gear, carrier or ring gear.

The transmission shaft of the multistage transmission according to claim 8 comprises a hollow portion which surrounds the center shaft and rotates, a plurality of radial through holes in an external circumference, is involved in the operation of the clutch assembly through the through holes and is controlled by the outside of the hub with respect to claim 1.

The transmission shaft includes a radial through hole to rotate between the center shaft and the sun gear and to couple or separate the sun gear and the center shaft. To couple the sun gear and the center shaft, a pawl which is supported by the center shaft is used, and is coupled to the sun gear through the radial through hole. Each pawl corresponds to the sun gear in 1:1, and the plurality of through holes corresponding to the pawls is formed in a circumferential direction in an axial direction in a main surface. The transmission shaft may protrude to the outside of the hub and may be controlled in a rotation direction.

The transmission shaft of the multistage transmission according to claim 9 provides a cam which is accommodated by the hollow portion of the center shaft in an axial direction and is involved in the operation of the clutch assembly through the radial through hole formed in the center shaft, and is controlled by the outside of the hub with respect to claim 1.

In this case, the transmission shaft rotates within the center shaft and includes a cam operation surface in a main surface to couple or separate the sun gear and the center shaft. To couple the sun gear and the center shaft, the pawl which has a supporting point in the center shaft and a cam controlled piece is used. The pawl stands or lies down with respect to the sun gear and controls the rotation of the sun gear in accordance with the shape of the cam operation surface. Accordingly, each pawl corresponds to the sun gear in 1:1, the plurality of cam operation surfaces corresponding to the pawls is formed in a circumferential direction in an axial direction in a main surface. The transmission shaft may protrude to the outside of the hub and may be controlled in a rotation direction.

The epicyclic gear set of the multistage transmission according to claim 10 has a pair of epicyclic gears arranged in parallel in the center shaft within the hub to rotate, and has one of two sun gears of the pair of the epicyclic gears coupled to the center shaft not to rotate and the other one of the sun gears rotate freely to be connected by a gear ratio of 1 or less and a gear ratio of 1 or more, and couples the two sun gears to rotate all together or couples one of the sun gear and the carrier to rotate all together and concurrently rotates the other one of the sun gears freely to ensure a 1:1 connection and provides a gear ratio of stage 12 between the input member and the output member by forming a gear ratio of stage 2 and one of a gear ratio of 1 or less and a gear ratio of 1 or more and a gear ratio of stage 2 of direct connection with respect to claim 9.

In this case, the gear ratio of stage 3 of the pair of epicyclic gears is formed by every ½ rotation of the transmission shaft. The gear ratio of stage 2 of the third epicyclic gear is formed by one rotation of the transmission shaft. The gear ratio of stage 2 of the fourth epicyclic gear is formed by two rotations of the transmission shaft. Accordingly, stage 12 of 3×2×2 may be formed.

The multistage transmission according to claim 11 is designed as a transmission with stage 3, stage 6, stage 9 or stage 12 and a gear ratio of the transmission is selected by one rotation of the transmission shaft with respect to claim 1.

In this case, stage 3 may be designed within 120°, and stage 6 may be designed by a combination of 3-stage transmission λ 2-stage transmission within 60°. Stage 9 may be designed by a combination of 3-stage transmission X 3-stage transmission within 40°. Twelve-stage transmission may be designed by a combination of 3-stage transmission X 2-stage transmission X 2-stage transmission within 30°. In particular, the 12-stage transmission may be formed at every ¼ rotation of the transmission shaft by the 3-stage transmission, and one of the 2-stage transmission may be formed at every ½ rotation of the transmission shaft and the other one of the 2-stage transmission may be formed by one rotation of the transmission shaft.

The multistage transmission according to claim 12 is designed as a transmission with stage 6, stage 12, or stage 18 and a gear ratio of the transmission is selected by two-rotation guide groove of the center shaft and two rotation of the transmission shaft with respect claim 1.

In this case, stage 6 may be designed within 120° in terms of interval of stages, the gear ratio of stage 2 may be formed at two rotations of the transmission shaft. Stage 12 may be designed within 60° in terms of interval of stages, and gear ratio of two stage 2 may be formed at every one rotation of the transmission shaft and at two rations. Stage 18 may have stage 9 formed at one rotation of the transmission shaft in which the gear ratio of stage 3 is arranged in series within 40°, and the gear ratio of stage 2 formed by two rotations of the transmission shaft.

The epicyclic gear of the epicyclic gear set according to claim 13 comprises at least one of a sun gear, an epicyclic gear and a ring gear with different specifications with respect to claim 1. The epicyclic gear of the pair of epicyclic gears according to claim 14 comprises a sun gear, a pinion and a ring gear with the same specifications with respect to claim 1.

If the pair of epicyclic gears includes gears with the same specification, stage 3 of direct connection (1:1), acceleration and deceleration which is in inverse proportion to the acceleration. As the two pairs of epicyclic gears having different gear ratios are coupled, the multistage transmission may have a consistent transmission ratio for each stage (refer to tables 2, 3, 5 and 6)

One of the ring gears of the pair of epicyclic gears according to claim 15 surrounds the other one of the ring gears and is coupled to one of the carriers and forms a cross coupling of the pair of epicyclic gears together with the one of the carriers coupled and the other one of the ring gear with respect to claim 1.

A ring gear adapter which is coupled to one of the ring gears not to rotate, and a carrier adapter which is coupled to the other one of the carriers not to rotate surround one of the ring gears not to rotate relatively.

The epicyclic gear of the multistage transmission according to claim 17 which is coupled to have the gear ratio of stage 2 has one of the sun gear, carrier and ring gear of the epicyclic gear coupled to the carrier of the pair of epicyclic gear, and has one of the sun gear and carrier of the epicyclic gear coupled to the center shaft not to rotate to provide a gear ratio of 1 or less or a gear ratio of 1 or more among the gear ratio of stage 2, and has the sun gear and the carrier coupled to each other not to rotate relatively and provides a direct-connection gear ratio among the gear ratio of stage 2 with respect to claim 4, 7, 10 or 12.

The hub of the multistage transmission according to claim 18 is coupled to the output member of the multistage transmission not to rotate with respect to claim 1.

In this case, the hub of the transmission rotates, and the hub transmission which is mounted in a rear wheel of a bicycle or a motorcycle may apply.

The multistage transmission according to claim 19 further comprises a rotation shaft which is rotatably installed by passing through the center shaft in an axial direction, and a gear, chain or a similar link which connects the rotation shaft to rotate together with the input member with respect to claim 1.

The transmission is employed in a bicycle or a similar device. The transmission is installed in a crank position of the bicycle, and the crank of the bicycle is installed by passing through the center shaft. As the crank shaft is connected to the input member by a link, the hub is fixed to the frame of the bicycle.

The multistage transmission according to claim 20 further comprises a rotation shaft which is rotatably installed in the frame and a gear, chain or a similar link which connects the rotation shaft to rotate together with the input member with respect to claim 1.

The transmission may include a general type of transmission in which a housing is fixed to the frame. If the transmission is employed in a bicycle, the transmission is installed in the vicinity of the bicycle crank, and the crank shaft and the input member are connected by the link and the hub is fixed to the frame of the bicycle.

The hub of the multistage transmission according to claim 21 comprises a housing that surrounds the input member and the output member to rotate and is fixed to the frame and further comprises a bracket to fix the center shaft to the frame with respect to claim 19 or 20.

In this case, the hub is fixed to the frame not to rotate, and concurrently the center shaft of the transmission is fixed to the frame by a bracket not to rotate.

The multistage transmission according to claim 22 further comprises a bevel gear mounted in the output side and a pinion gear which is supported by the housing and rotates by being engaged with the bevel gear with respect to claim 21.

In this case, a chainless bicycle which transmits the rotational force to a rear wheel hub without chain may be formed by using the crank transmission.

The pinion gear of the multistage transmission according to claim 23 is coupled to the output side to transmit the rotational force of the output side to the outside, and further comprises a hollow tube which is coupled to the housing and supports and surrounds the pinion gear and the output side with respect to claim 22.

In this case, the tube which surrounds a transmission shaft of the chainless bicycle may be installed between the hub of the transmission and the rear wheel hub.

### Advantageous Effect

As described above, a transmission according to the present invention provides various transmission stages and uniform increase in gear ratio, and has a small structure and a light weight. The transmission according to the present invention ensures a quick transmission by a small force without cutting off or bypassing power for such transmission even while driving or suspension and has each stage converted into another stage without being converted sequentially.

### BRIEF DESCRIPTION OF DRAWINGS

FIG. 1 is a sectional view of a hub transmission which may be installed in a rear wheel of a bicycle as an example of a multistage transmission according to the present invention.

FIG. 2 illustrates the transmission in FIG. 1.

FIG. 3 illustrates a transmission which may be installed in the vicinity of a bicycle crank as an example of the multistage transmission according to the present invention.

FIG. 4 is an exploded perspective view of the transmission in FIG. 1.

FIG. 5 is an exploded perspective view of a pair of epicyclic gears in an input side.

FIG. 6 is an exploded perspective view of a pair of epicyclic gears in an output side in FIG. 4.

FIG. 7 is an exploded perspective view of a center shaft and a transmission shaft in FIG. 4.

FIG. 8 is an exploded perspective view of a 2-stage epicyclic gear in an output side in FIG. 4.

FIG. 9 illustrates a fifth epicyclic gear in FIG. 1.

FIG. 10 illustrates an operation of a pawl of the transmission in FIG. 1.

### BEST MODE

Terms and words used in this application and the claims herein shall not be interpreted as only customary or dictionary meanings. Instead, such terms and words shall be interpreted as the meaning and concept consistent with the technical spirit of the present invention in accordance with the principle that the inventor may properly define the meaning of terms to explain his/her invention in a best manner.

Accordingly, exemplary embodiments stated in this application and the configurations shown in drawings are preferably exemplary embodiments according to the present invention, but do not represent all of the technical spirit of the present invention. As a result, it shall be understood that there may be various equivalents and modifications which may replace the exemplary embodiments of the present invention at the time of filing this application.

The term “axial direction” is used to refer to the direction or location along the shaft in parallel with a center shaft of the transmission. The terms “radius” and “radial direction” are used to refer to the direction or location extending vertically to the center shaft of the transmission. For clarity and simplicity, like elements with like reference numerals (e.g., pawl spring 64a and pawl spring 64b) will be named as single reference numerals (e.g., a pawl spring 64).

Hereinafter, a multistage transmission according to exemplary embodiments of the present invention will be described in detail with reference to accompanying drawings. Even though a transmission according to a present exemplary embodiment is employed in a bicycle, it may be employed in any device which converts an input speed for output.

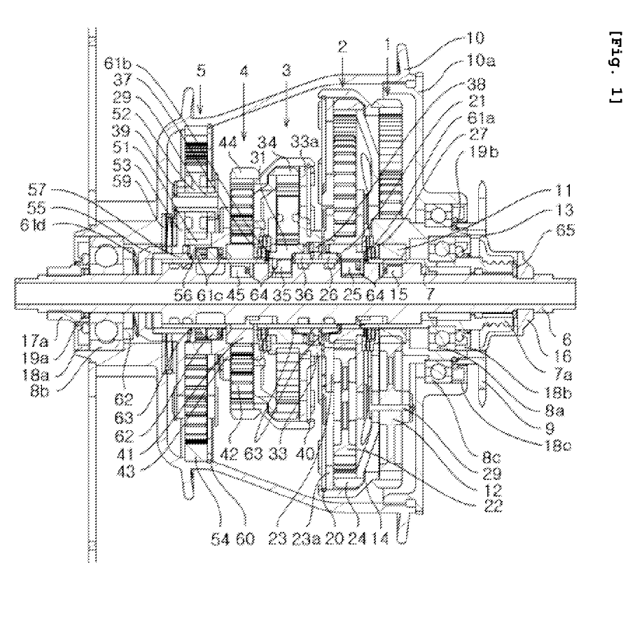

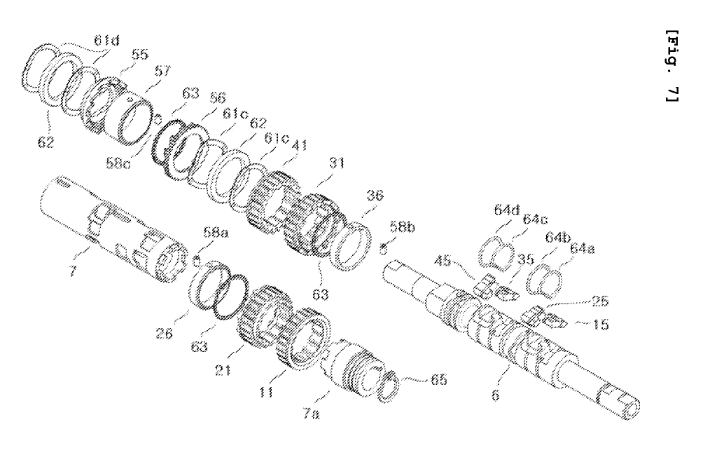

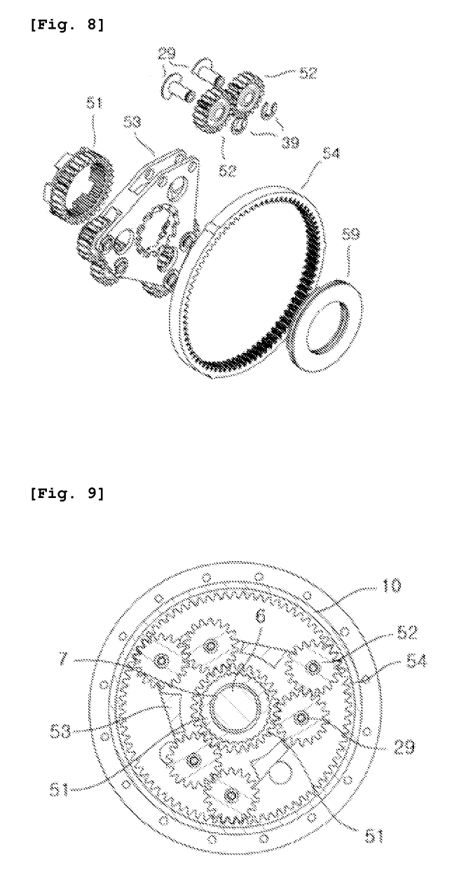

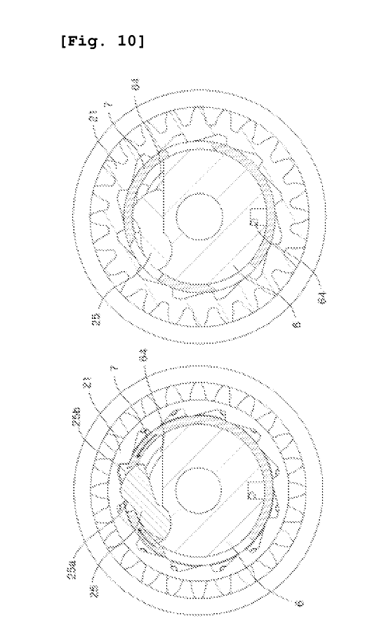

Referring to FIGS. 1 and 7, a center shaft 6 of a multistage transmission according to the present invention includes a shaft which has a step 6e and a hollow through hole 6f in opposite section to be installed in a frame (not shown) such that the center shaft 6 does not rotate. Two direct-connection clutch guide groove 6a are formed in a central surface of the center shaft 6, and a concave cam surface 6b is formed in an axial direction in a lateral surface of each groove toward a counterpart groove for a direct-connection clutch. The concave groove of the cam surface 6b is programmed in advance to operate direct-connection clutches 21 and 31, and is set at a proper interval upon determination of a transmission stage. The concave groove is programmed at an interval of 40° for 9 speed transmission.

A pair of concave pawl grooves 6c are formed in an axial direction at a predetermined interval to accommodate therein ratchet pawls 15, 25, 35 and 45 in opposite surfaces of the center shaft 6. A pawl spring groove 6g is formed in each of the pawl grooves 6c to accommodate therein pawl springs 64a, 64b, 64c and 64d to apply an elastic force so that the pawls 15, 25, 35 and 45 may rotate and stand.

Two-rotation clutch guiding groove 6d is formed as in FIG. 7 with respect to two-stage clutch 5. A first rotation 6d1 is performed from zero degree to 320° by maintaining a position in an axial direction, and moves in the axial direction from 320° to 360° while a second rotation 6d2 maintains an original position in an axial direction from 360° to 680°.

A transmission shaft 7 is a tubular member which surrounds the center shaft 6 and rotates. The transmission shaft 7 include a transmission shaft 7 including a plurality of pawl operation holes 7b engaging in the operation of the ratchet pawls 15, 25, 35 and 45 in a main surface and a guide groove guiding the 2-stage clutch guiding pin 58c and the direct-connection clutch guiding pin 58b in a rotation direction, and a transmission shaft 7 including a groove 7f fixing a transmission wire connected to control a rotation of the transmission shaft from the outside and a wire 7e to wind the transmission wire. The transmission shafts 7 and 7a are coupled by an uneven projection not to rate relatively. The transmission shaft 7 is fixed to the center shaft 6 by a lateral wall 6h of the center shaft 6 and a snap ring 65 fixed to the center shaft 6 not to be moved in an axial direction, and has a step formed to support a bearing 8a in an axial direction.

The pawl operation hole 8b of the transmission shaft 7 is a through hole in a radial direction and provides a space to permit the pawl to stand. The pawl operation hole 8b is programmed in advance at a proper interval to operate the pawls 15, 25, 35 and 45 once the transmission stage is determined. Here, the pawl operation hole 8b is programmed at an interval of 40° to enable a 9-stage transmission. Guide pin guiding grooves 7c and 7d are through holes elongated in an axial direction.

A lateral wall 7e of the pawl operation hole 7b in a rotation direction is involved in the operation that the pawls 15, 25, 35 and 45 are inserted into the respective pawl grooves 6c, and is inclined to efficiently insert the pawls 15, 25, 35 and 45 into the grooves 6c in cooperation with the pawl cams 25a and 25b not to receive a rotational resistance from the pawls 15, 25, 35 and 45 when the transmission shaft 7 rotates and controls the pawls 15, 25, 35 and 45.

The pawls 15, 25, 35 and 45 are rotational members which stand toward sun gears 11, 21, 31 and 41 or inserted into the pawl grooves 6c of the center shaft 6 by a control of the transmission shaft 7 with the supporting point in the center shaft 6 between the center shaft 6 and the transmission shaft 7. Projections are formed in opposite sides of the pawls to support the pawls and to prevent the pawls from being separated from their positions. Pawl guiding cams 25a and 25b are formed in one side of the pawls 15, 25, 35 and 45 which guides the pawls 15, 25, 35 and 45 to be inserted into the pawl grooves 6c by a rotation of the transmission shaft 7 guide the pawls 15, 25, and 45 to be efficiently inserted into the pawl grooves 6c by a rotation of the transmission shaft 7 clockwise or counterclockwise. The pawls 15, 25, 35 and 45 receives the force from springs 64a, 64b, 64c and 64d surrounding the pawls 15, 25, 35 and 45 to stand, and stand toward the sun gears 11, 21, 31 and 41 when the through hole 7b of the transmission shaft 6 allows the standing of the pawls 15, 25, 35 and 45.

The pawls 15, 25, 35 and 45 are installed such that they stand in opposite directions within the same pair of epicyclic gears to prevent a rotation of the sun gears 11, 21, 31 and 41 and to ensure a change in speed. In an exemplary embodiment in which the power is transmitted by a clockwise rotation, an input pawl 15 of a pair of epicyclic gears 1 and 2 in an input side is arranged to prevent the clockwise rotation of the sun gear 11 while the pawl 25 in an output side is arranged to prevent a counterclockwise rotation of the sun gear 21. In a pair of epicyclic gears 3 and 4 in an output side, an input pawl 35 is arranged to prevent a clockwise direction of the sun gear 31 while an output pawl 45 is arranged to prevent a counterclockwise rotation of the sun gear 41.

Direct-connection clutch guide rings 26 and 36 are installed to surround the transmission shaft 7, support the sun gears 21 and 31 pressing the guide rings 26 and 36 in an axial direction and are coupled to the direct-connection clutch guide pins 58a and 58b to move in an axial direction along the guide pines 58a and 58b. A bearing 63 is installed between the direct-connection clutch guide rings 26 and 36 and the sun gears 21 and 31 to reduce friction caused by the rotation of the sun gears 21 and 31. The direct-connection guide pins 58a and 58b are coupled to the direct-connection clutch guide rings 26 and 36, and rotate together with the transmission shaft 7 through the through hole 7c elongated in an axial direction of the transmission shaft 7 and along the cam surface 6b of the direct-connection clutch guide groove formed in the center shaft 6 to move in an axial direction.

The 2-stage clutch guide ring 57 is installed to surround the transmission shaft 7, to be coupled to the 2-stage clutch guide pin 58c and to move in an axial direction along the guide pin 58c. The 2-stage clutch guide pin 58c is coupled to the 2-stage clutch guide ring 57 and rotates together with the transmission shaft 7 through the 2-stage clutch guide pin guide groove 7d as a through hole elongated in an axial direction of the transmission shaft 7 and along the cam surface of the 2-stage clutch guide groove 6d formed in the center shaft 6, maintains its original position in an axial direction by the first rotation 6d1 of the transmission shaft 7 and moves in an axial direction by the second rotation 6d2.

A 2-stage transmission clutch 55 and a 2-stage direct-connection clutch 56 are arranged in opposite sides of the 2-stage clutch guide ring 57. The 2-stage transmission clutch 55 contacts the 2-stage clutch guide ring 57 by being pressed by a spring 61d and fixed to the center shaft 6 not to rotate and moves in an axial direction along the 2-stage clutch guide ring 57, wherein an inclined step is formed in a lateral side toward the 2-stage direct-connection clutch 56 to prevent a clockwise direction. The 2-stage direct-connection clutch 56 contacts the 2-stage clutch guide ring 57 by being pressed by a spring 61c, is coupled to the 2-stage clutch sun gear 51 not to rotate relatively, and moves in an axial direction along the 2-stage clutch guide ring 57, wherein an inclined step is formed in a lateral side toward the 2-stage transmission clutch 55 to prevent a counterclockwise rotation.

The sun gears 11 and 41 have an inclined groove formed in an internal circumference thereof for the ratchet pawls 15 and 45, and a lateral wall formed in a lateral side thereof. The lateral wall is disposed between carriers 13 and 43 and a pinion 1242 so that the sun gears 11 and 41 do not move in an axial direction. The respective sun gears 11 and 41 are arranged in an axial direction to be coupled with the pawls 15 and 45, respectively. The sun gear 11 has an inclination arranged to prevent a clockwise rotation while the sun gear 41 has an inclination arranged to prevent a counterclockwise rotation.

The sun gears 21 and 31 have an inclined groove formed in an internal circumference for the ratchet pawls 25 and 35, and an inclined step is formed in one side of the sun gears 21 and 31 to prevent a rotation in one direction. The respective sun gears 21 and 31 are arranged in an axial direction to be coupled with the pawls 25 and 35. The sun gear 21 has an inclination arranged to prevent a counterclockwise rotation, and a lateral inclined step protrudes toward the sun gear 31 to prevent a counterclockwise rotation. The sun gear 31 has an inclination arranged to prevent a counterclockwise rotation, and a lateral inclined step protrudes toward the sun gear 21 to prevent a clockwise rotation.

The sun gears 21 and 31 are pressed by the springs 51a and 61b and surround the direct-connection clutch guide rings 26 and 36, and move in an axial direction by the movement of the direct-connection clutch guide rings 26 and 36 in an axial direction to thereby be coupled to or separated from the direct-connection clutch ring 38.

The direct-connection clutch ring 38 is coupled to the carrier 33 of the epicyclic gear between the two sun gears 21 and 31 not to rotate, and an inclined step in an axial direction is formed in opposite direction to prevent the rotation of the sun gears 21 and 31 by being coupled to a lateral projection of the sun gears 21 and 31. In the direct-connection clutch ring 38, an inclined step in an axial direction is formed in a side contacting the sun gear 21 to prevent a counterclockwise rotation of the sun gear 21, and an inclined step in an axial direction is formed in another side contacting the sun gear 31 to prevent a clockwise rotation of the sun gear 31.

If the direct-connection clutch guide cam surface 6b is flat and the direct-connection clutch is separated, the direct-connection cutch guide ring 26 presses the sun gear 21 and guides the sun gear 21 to a location not to be coupled to the direct-connection clutch ring 38. In a location in which the direct-connection clutch guide cam surface 7b is concave, the direct-connection clutch guide ring 26 progresses together with the sun gear 21 by the pressure of the spring 61a. As a result, the direct-connection clutch ring 38 is coupled to the sun gear 21.

If the direct-connection clutch guide cam surface 6b is flat and the direct-connection clutch is separated, the direct-connection cutch guide ring 26 presses the sun gear 21 and guides the sun gear 21 to a location not to be coupled to the direct-connection clutch ring 38. In a location in which the direct-connection clutch guide cam surface 7b is concave, the direct-connection clutch guide ring 26 progresses together with the sun gear 21 by the pressure of the spring 61a. As a result, the direct-connection clutch ring 38 is coupled to the sun gear 21.

The epicyclic gear set may include 3, 6, 9, 12 or 18 stages based on a pair of epicyclic gears. As an example, if a pair of epicyclic gears 1-2 in an input side, a pair of epicyclic gears 3-4 in an output side and 2-stage epicyclic gear 5 are coupled in series, an epicyclic gear transmission which provides 18 stage gears may be provided.

The pairs of epicyclic gears 1-2 and 3-4 include two epicyclic gears 1 and 2 or 3 and 4, wherein one epicyclic gear operates in an input side of the pair of epicyclic gears and the other epicyclic gear operate in an output side of the pair of epicyclic gears. The sun gear of the pair of epicyclic gears is used to control change in speed, and a carrier integrally coupled to the ring gear operates in an input side and an output side of the pair of epicyclic gears.

An input carrier 13 of the pair of epicyclic gears 1-2 in an input side in FIG. 5 has a through hole having a step to support and accommodate the sun gear 11, and three grooves to accommodate three pinions 12 and three through holes in an axial direction to support a pinion shaft 29. A screw is formed in an external circumference protruding from one side of the carrier 13 to be coupled with a sprocket, and a cylindrical member having a through hole to accommodate a bearing is formed in an internal circumference. In an opposite side, a groove is formed to accommodate a thrust bearing 27.

The pinion 12 is installed to rotate together with the carrier 13 by being fixed to the carrier 13 by the pinion shaft 29 fixed to three through holes of the carrier by the snap ring 39. The sun gear 11 rotates as the lateral wall of the sun gear 11 is supported by a supporting projection of the carrier 13 and being engaged with the pinion 12 and fixed to the carrier 13 in an axial direction.

An output carrier 23 of the pair of epicyclic gears in an input side has a through hole to accommodate the sun gear 21, and three grooves to accommodate three pinions 22 and three through holes in an axial direction to support the pinion shaft 29, and a projection is formed in one side to be coupled with the input carrier 33 of the pair of epicyclic gears 3-4 in an output side. In an opposite side, a groove is formed to accommodate the thrust bearing 27.

The pinion 22 is installed to rotate together with the carrier 23 by being fixed to the carrier 23 by the pinion shaft 29 fixed to three through holes of the carrier 23 by the snap ring 39. The sun gear 21 rotates as the lateral wall of the sun gear 21 is supported in an axial direction by the spring 61a supported by the thrust bearing 27 and being engaged with the pinion 22 for rotation.

The ring gear 24 in an output side extends in a radial direction and is coupled to the input carrier 13 not to rotate. The ring gear 14 in an input side extends in an axial direction, surrounds the ring gear 24 in an output side to be coupled with an output carrier adaptor 23a extending from the output carrier 23 by an uneven projection not to rotate.

The thrust bearing 27 is installed between the input carrier 13 and the output carrier 23, maintains the gap therebetween and supports a spring pressing the sun gear 21.

An input carrier 33 of the pair of epicyclic gears 3-4 in an output side coupled to the pair of epicyclic gears 1-2 in an input side not to rotate has a through hole to accommodate the sun gear 31, three grooves to accommodate three pinions 32 and three through holes in an axial direction to support the pinion shaft 29, and a projection is formed in one side to be coupled to an output carrier 23 of the pair of epicyclic gears 1-2 in an input side and the direct-connection clutch ring 38. In an opposite side, a groove is formed to accommodate the thrust bearing 37.

The pinion 32 is installed to rotate together with the carrier 33 by being fixed to the carrier 33 by the pinion shaft 29 fixed to three through holes of the carrier 33 by the snap ring 39. The sun gear 31 rotates as the lateral wall of the sun gear 31 is supported in an axial direction by the spring 61b supported by the thrust bearing 37 and being engaged with the pinion 32 for rotation.

An output carrier 43 of the pair of epicyclic gears 3-4 in an output side has a through hole having a step to support and accommodate the sun gear 41, three grooves to accommodate three pinions 42 and three through holes in an axial direction to support the pinion shaft 29, and a projection is formed in one side of the carrier 43 to be coupled to a 2-stage clutch sun gear 51. In an opposite side, a groove is formed to accommodate the thrust bearing 37.

The pinion 42 is installed to rotate together with the carrier 43 by being fixed to the carrier 43 by the pinion shaft 29 fixed to three through holes of the carrier 43 by the snap ring 39. The sun gear 41 rotates as the lateral wall of the sun gear 41 is supported by a supporting projection of the carrier 43 and being engaged with the pinion 42 and fixed to the carrier 43 in an axial direction for rotation.

The ring gear 34 in an input side extends in a radial direction and is coupled to the output carrier 43 not to rotate. The ring gear 44 in an output side extends in an axial direction, surrounds the ring gear 34 in an input side to be coupled with an input carrier adaptor 33a extending from the input carrier 23 by an uneven projection not to rotate.

The thrust bearing 37 is installed between the input carrier 33 and the output carrier 43, maintains the gap therebetween and supports a spring pressing the sun gear 31.

The 2-stage transmission epicyclic gear 5 may use one of the sun gear 51 and the carrier 53 as a fixing element; use the sun gar, the carrier and the ring gear as an input element; and the ring gear and the carrier as an output element. If the sun gear is used as the fixing element, one of deceleration and direct connection and acceleration and direct connection. If the carrier is used as the fixing element, deceleration and direct-connection transmission is possible. In the case of deceleration, a double pinion is used.

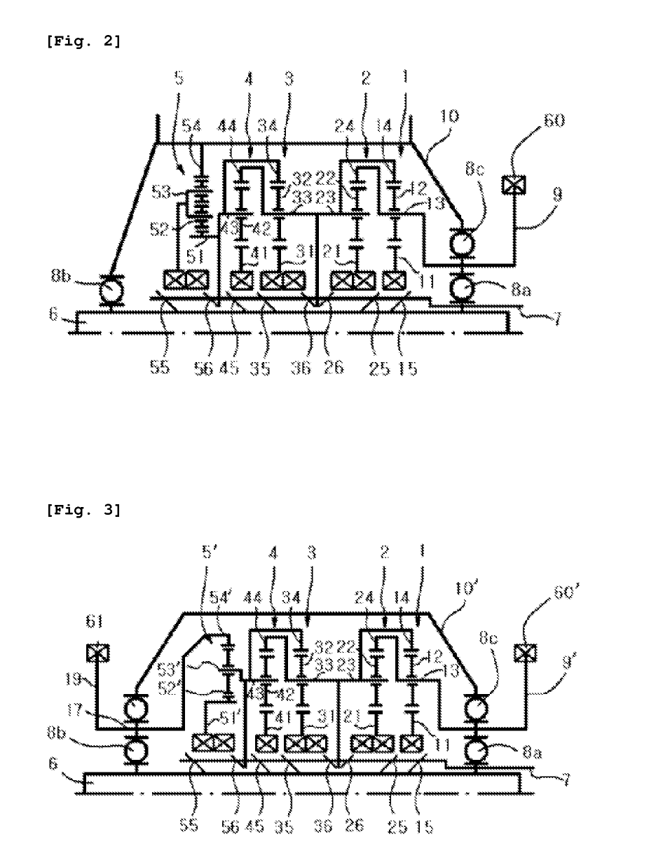

Referring to FIG. 2, the carrier 53 is used as the fixing element to constitute deceleration and direct-connection transmission, and the carrier 53 operates with opposite clutches. The carrier 53 surrounds the 2-stage clutch guide ring 57 between the 2-stage transmission clutch 55 and the 2-stage direct-connection clutch 56, includes a groove to accommodate the pinion 52, and 6 through holes in an axial direction to fix the pinion 52 to the carrier 53. An inclined projection is formed in a lateral wall of the carrier 53 facing a housing 10 to be coupled with the 2-stage transmission clutch 55 and prevent a counterclockwise rotation of the carrier 53, and an inclined projection is formed in a lateral wall facing the pair of epicyclic gears 3-4 in an output side to be coupled with the 2-stage direct-connection clutch 56 and rotate with the clockwise rotation of the 2-stage direct-connection clutch 56. The location of the carrier 53 in an axial direction is fixed and maintained by the thrust bearing 59 supported by the housing 10 and the 2-stage clutch sun gear 51.

The pinion 52 is fixed to the carrier 53 by the pinion shaft 29, and rotates together with the carrier by being engaged with the 2-stage clutch sun gear 51 and the ring gear 54.

The 2-stage clutch sun gear 51 is coupled to the output carrier 43 of the pair of epicyclic gears 3-4 in an output side not to rotate relatively, supports the lateral wall of the carrier 53, surrounds and is coupled to the 2-stage direct-connection clutch 56 to rotate.

If the 2-stage clutch guide ring 57 moves in an axial direction by a rotation of the transmission shaft 7, the 2-stage transmission clutch 55 and the 2-stage direct-connection clutch 56 move in an axial direction and are coupled to the inclined step of the carrier 53. If the 2-stage clutch guide pin 58c is within the first-rotation guide groove 6d1, the 2-stage direct-connection clutch 56 progresses to the carrier 53 and is coupled with the 2-stage direct-connection clutch 56, and the carrier 53 is coupled with the sun gear 51 and operates as a single body to ensure a direct-connection transmission. If the 2-stage clutch guide pin 58c is within the second-rotation guide groove 6d2, the 2-stage transmission clutch 55 progresses to the carrier 53 and is coupled with the 2-stage transmission clutch 55 to fix the carrier 53 to the center shaft 5 for transmission.

The ring gear 54 is coupled to the housing 10 as a hub of the transmission not to rotate relatively. Accordingly, if a rotational force of the pinion 52 is transmitted, the housing 10 rotates.

The housing 10 includes a housing which surrounds the epicyclic gear set, is coupled with the ring gear 54 and includes a flange to transmit power to wheels, and a lid 10a which seals the housing to prevent any impurities from being introduced to the housing and to isolate the epicyclic gear set from the outside.

The housing 10 is supported by a bearing 18a fixed to the center shaft 6 by a fixing nut 17a, and the lid 10a is supported by a bearing 8c fixed to the input carrier 13 by a sprocket 9. As a result, the housing 10 and the lid 10a rotate all together.

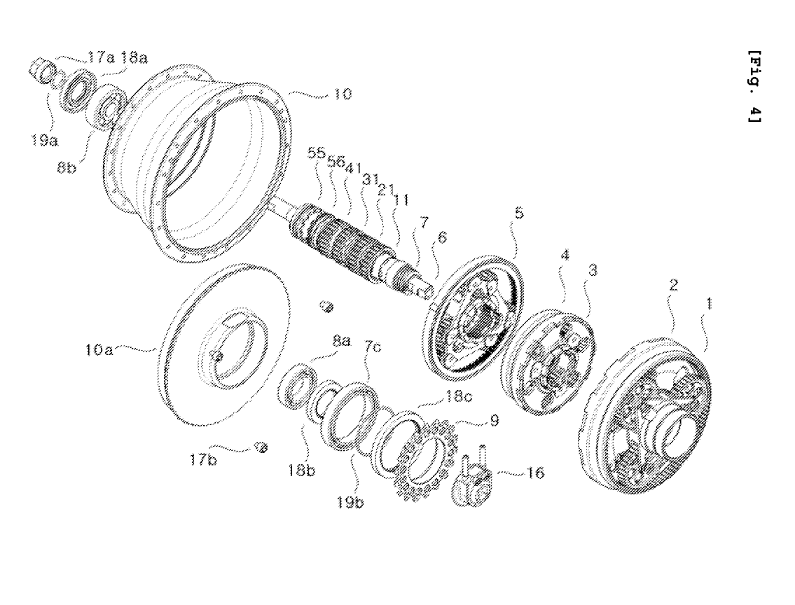

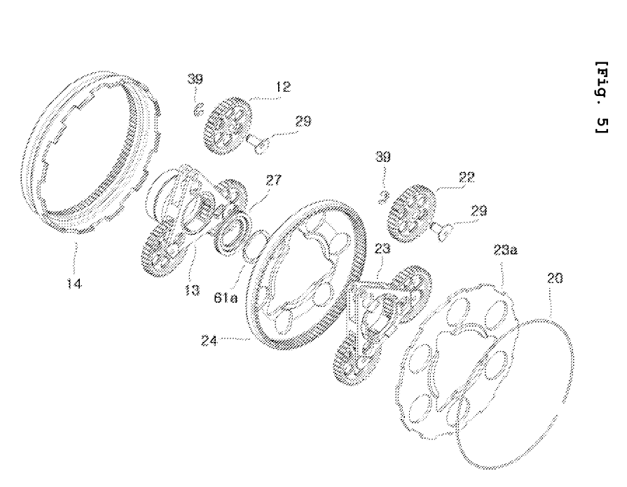

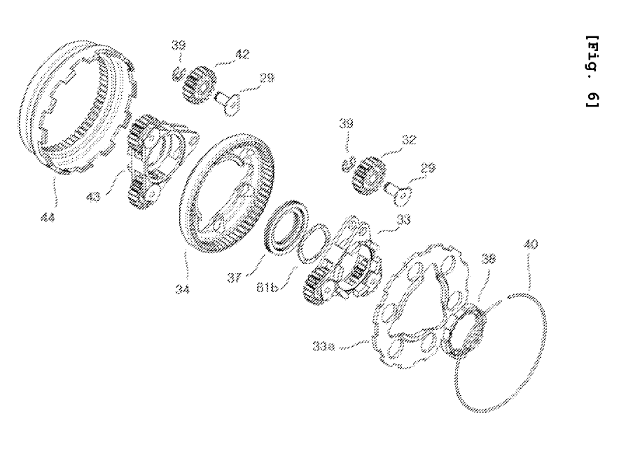

Referring to FIG. 3, a transmission which may be installed in the vicinity of a bicycle crank is shown. A housing 10′ of the transmission is installed closely to the crank and does not rotate with respect to a frame. The rotational force of the crank is transmitted to an input side 9′ of the transmission through a chain or belt 60. A fifth epicyclic gear uses a sun gear 51′ as a fixing element. The sun gear 51′ operates with opposite clutches and uses a single pinion for acceleration and direct-connection transmission. An output side 19 of the transmission transmits power to rear wheels through a sprocket or belt 61.

### First Exemplary Embodiment

Four epicyclic gears were used to form a epicyclic gear set with the gear configuration as in table 1. A transmission shaft has a through hole formed in main surface as in clutches 15, 25, 35 and 45 in table 2, wherein each stage is arranged at an interval of 40° and is open in the width of 50°. As an overlapping part is shared, no problem arises in the operation of pawls. The center shaft has a cam groove formed in an axial direction in a main surface thereof as in clutches 26 and 36 in table 2, wherein each stage is arranged at an interval of 40°. A pair of input epicyclic gears is formed by arranging clutches 15, 25 and 26 in table 2, and a pair of output epicyclic gears is formed by arranging clutches 36, 35 and 45. Increase of transmission at each stage is relatively uniform from 13.3% to 13.8% from 2 stage to 8 stage. At both ends, the transmission increased sharply to 29% and the degree of transmission is 356%.

TABLE 1

| | gear number | number of teeth |
|---|---|---|
| sun gear | 11, 21 | 27 |
| | 31, 41 | 36 |
| epicyclic gear | 12, 22 | 30 |
| | 32, 42 | 21 |
| internal tooth gear | 14, 24 | 93 |
| | 34, 44 | 78 |

TABLE 2

| | | | | | | | input/ | gear |
|---|---|---|---|---|---|---|---|---|
| Trans- | clutch no. (gear ratio) | | | | | | output | ratio |
| mission | 15 | 25 | 26 | 36 | 35 | 45 | gear | increasing |
| stage | (1.290) | (0.775) | (1.000) | (1.000) | (1.463) | (0.684) | ratio | ratio(%) |
| 1st | X | | | X | | | 1.887 | |
| stage | | | | | | | | |
| 2nd | | X | | X | | | 1.463 | 29.1 |
| stage | | | | | | | | |
| 3rd | X | | | | X | | 1.290 | 13.3 |
| stage | | | | | | | | |
| 4th | | | X | X | | | 1.134 | 13.8 |
| stage | | | | | | | | |
| 5th | | X | | | X | | 1.000 | 13.4 |
| stage | | | | | | | | |
| 6th | X | | | | | X | 0.882 | 13.4 |
| stage | | | | | | | | |
| 7th | | | X | | X | | 0.775 | 13.8 |
| stage | | | | | | | | |
| 8th | | X | | | | X | 0.684 | 13.4 |
| stage | | | | | | | | |
| 9th | | | X | | | X | 0.530 | 29.0 |
| stage | | | | | | | | |

### Second Exemplary Embodiment

Based on the first exemplary embodiment, a transmission with a uniform degree of transmission has been designed. A 2-stage epicyclic gear has been added to the composition of tables 1 and 2, except for opposite ends with a large degree of transmission, and with the gear composition as in table 3 to thereby form a transmission with 14 stages with two-rotation of a transmission shaft as in table 4.

As one rotation is 7 stages, each stage has been arranged at an interval of 51.4°, and a deceleration ratio of 2-stage clutch has been set as 0.413. Increase in transmission at each stage was relatively uniform from 13.3% to 13.8%, and the degree of transmission was 519% with large transmission area.

TABLE 3

| | gear number | number of teeth |
|---|---|---|
| sun gear | 11, 21, 51 | 27 |
| | 31, 41 | 36 |
| epicyclic gear | 12, 22 | 30 |
| | 32, 42 | 21 |
| | 52a, 52b | 18 |
| internal tooth gear | 14, 24 | 93 |
| | 34, 44 | 78 |
| | 54 | 66 |

TABLE 4

| | | | | | | | | | Input/ | Gear |
|---|---|---|---|---|---|---|---|---|---|---|
| Trans- | Clutch no. (gear ratio) | | | | | | | | Output | ratio |
| mission | 15 | 25 | 26 | 36 | 35 | 45 | 155 | 56 | gear | increasing |
| stage | (1.290) | (0.775) | (1.000) | (1.000) | (1.463) | (0.684) | (0.413) | (1.00) | ratio | ratio(%) |
| 1st | | X | | X | | | | X | 1.463 | |
| stage | | | | | | | | | | |
| 2nd | X | | | | X | | | X | 1.290 | 13.3 |
| stage | | | | | | | | | | |
| 3rd | | | X | X | | | | X | 1.134 | 13.8 |
| stage | | | | | | | | | | |
| 4th | | X | | | X | | | X | 1.000 | 13.4 |
| stage | | | | | | | | | | |
| 5th | X | | | | | X | | X | 0.882 | 13.4 |
| stage | | | | | | | | | | |
| 6th | | | X | | X | | | X | 0.775 | 13.8 |
| stage | | | | | | | | | | |
| 7th | | X | | | | X | | X | 0.684 | 13.4 |
| stage | | | | | | | | | | |
| 8th | | X | | X | | | X | | 0.604 | 13.3 |
| stage | | | | | | | | | | |
| 9th | X | | | | X | | X | | 0.532 | 13.3 |
| stage | | | | | | | | | | |
| 10th | | | X | X | | | X | | 0.468 | 13.8 |
| stage | | | | | | | | | | |
| 11th | | X | | | X | | X | | 0.413 | 13.4 |
| stage | | | | | | | | | | |
| 12th | X | | | | | X | X | | 0.364 | 13.4 |
| stage | | | | | | | | | | |
| 13th | | | X | | X | | X | | 0.320 | 13.8 |
| stage | | | | | | | | | | |
| 14th | | X | | | | X | X | | 0.282 | 13.4 |
| stage | | | | | | | | | | |

### Third Exemplary Embodiment

To design a transmission which has a finer increase in transmission and large degree of transmission, 18-stage transmission has been designed as in table 7 based on a 9-stage transmission as in tables 5 and 6.

A deceleration ratio of the 2-stage clutch has been set as 0.363 to make the increase in transmission consistent while including the opposite ends in table 6. Except for the opposite sides, the increase in transmission increased relatively uniformly from 11.4% to 12.3%. The degree of transmission was 538% and achieved a large transmission area. If the opposite ends are included, the degree of transmission was 841% and achieved a large transmission area. In the present exemplary embodiment, 9 stage and 10 stage should be changed in order.

TABLE 5

| | | number | |
|---|---|---|---|
| | gear number | of teeth | Remark |
| sun gear | 11, 21 | 24 | |
| | 31, 41 | | |
| | 51 | 30 | Excluded 9 stage |
| epicyclic | 12, 22 | 36 | |
| gear | 32, 42, 52a, 52b | 18 | 52a, 52b excluded |
| | | | from 9 stage |
| internal | 14, 24 | 96 | |
| tooth gear | 34, 44 | 60 | |
| | 54 | 81 | Excluded 9 stage |

TABLE 6

| | | | | | | | input/ | gear |
|---|---|---|---|---|---|---|---|---|
| trans- | clutch no. (gear ratio) | | | | | | output | ratio |
| mission | 15 | 25 | 26 | 36 | 35 | 45 | gear | increasing |
| stage | (1.25) | (0.8) | (1.00) | (1.00) | (1.4) | (0.714) | ratio | ratio (%) |
| 1st | X | | | | X | | 1.750 | |
| stage | | | | | | | | |
| 2nd | | | X | | X | | 1.400 | 25.0 |
| stage | | | | | | | | |
| 3rd | X | | | X | | | 1.250 | 12.0 |
| stage | | | | | | | | |
| 4th | | X | | | X | | 1.120 | 11.6 |
| stage | | | | | | | | |
| 5th | | | X | X | | | 1.000 | 12.0 |
| stage | | | | | | | | |
| 6th | X | | | | | X | 0.893 | 12.0 |
| stage | | | | | | | | |
| 7th | | X | | X | | | 0.800 | 11.6 |
| stage | | | | | | | | |
| 8th | | | X | | | X | 0.714 | 12.0 |
| stage | | | | | | | | |
| 9th | | X | | | | X | 0.571 | 25.0 |
| stage | | | | | | | | |

TABLE 7

| | | | | | | | | | input/ | gear |
|---|---|---|---|---|---|---|---|---|---|---|
| trans- | clutch no. (gear ratio) | | | | | | | | output | ratio |
| mission | 15 | 25 | 26 | 36 | 35 | 45 | 55 | 56 | gear | increasing |
| stage | (1.25) | (0.8) | (1.00) | (1.00) | (1.4) | (0.714 | (0.363) | (1.0) | ratio | ratio (%) |
| 1st | X | | | | X | | | X | 1.750 | |
| stage | | | | | | | | | | |
| 2nd | | | X | | X | | | X | 1.400 | 25.0 |
| stage | | | | | | | | | | |
| 3rd | X | | | X | | | | X | 1.250 | 12.0 |
| stage | | | | | | | | | | |
| 4th | | X | | | X | | | X | 1.120 | 11.6 |
| stage | | | | | | | | | | |
| 5th | | | X | X | | | | X | 1.000 | 12.0 |
| stage | | | | | | | | | | |
| 6th | X | | | | | X | | X | 0.893 | 12.0 |
| stage | | | | | | | | | | |
| 7th | | X | | X | | | | X | 0.800 | 11.6 |
| stage | | | | | | | | | | |
| 8th | | | X | | | X | | X | 0.714 | 12.0 |
| stage | | | | | | | | | | |
| 9th | X | | | | X | | X | | 0.636 | 12.3 |
| stage | | | | | | | | | | |
| 10th | | X | | | | X | | X | 0.571 | 11.4 |
| stage | | | | | | | | | | |
| 11th | | | X | | X | | X | | 0.509 | 12.2 |
| stage | | | | | | | | | | |
| 12th | X | | | X | | | X | | 0.455 | 11.9 |
| stage | | | | | | | | | | |
| 13th | | X | | | X | | X | | 0.407 | 11.8 |
| stage | | | | | | | | | | |
| 14th | | | X | X | | | X | | 0.364 | 11.8 |
| stage | | | | | | | | | | |
| 15th | X | | | | | X | X | | 0.325 | 12.0 |
| stage | | | | | | | | | | |
| 16th | | X | | X | | | X | | 0.291 | 11.7 |
| stage | | | | | | | | | | |
| 17th | | | X | | | X | X | | 0.260 | 11.9 |
| stage | | | | | | | | | | |
| 18th | | X | | | | X | X | | 0.208 | 25.0 |
| stage | | | | | | | | | | |

1. A multistage transmission comprising:
a center shaft arranged in a frame such that the center shaft does not rotate;
an input member arranged coaxially with the center shaft such that the input member is rotatable;
an epicyclic gear set which is coupled to the input member and mounted on the hub, and which is arranged coaxially with the center shaft such that the epicyclic gear set is rotatable, and which has at least two pairs of epicyclic gears which are arranged in parallel to each other, wherein each of the epicyclic gears has a sun gear, a ring gear, a carrier and a pinion, and wherein the ring gears and the carriers of said two adjacent pairs of epicyclic gears cross each other and are coupled together so as to be prevented from rotating;
a clutch assembly which is involved in the operation of each of the sun gears which is selectively coupled to and separated from the ring gear, the carrier, the pinion, the sun gear adjacent thereto and/or the center shaft;
a transmission shaft which is arranged coaxially with the center shaft to select a rotating direction with respect to the center shaft, and which is involved in the operation of the clutch assembly; and
a hub arranged coaxially with the center shaft such that the hub is rotatable, and the multistage transmission providing gear ratios of stage 3 or more between the input member and the hub in accordance with the rotating direction of the transmission shaft.

2. The multistage transmission according to claim 1, wherein the epicyclic gear set has a plurality of sun gears arranged at a distance in an axial direction to be selectively coupled to the center shaft by a plurality of concave coupling surfaces, and a guide slit formed in a main surface of the center shaft and selectively coupled to the sun gear, a plurality of pawls supported by the guide slit and coupled to or separated from the sung gear and a plurality of transmission shaft through holes formed in a main surface of the transmission shaft.

3. The multistage transmission according to claim 1, wherein the pair of epicyclic gears have two pairs of epicyclic gears arranged in parallel in the center shaft to rotate, and has one of two sun gears of the pair of the epicyclic gears coupled to the center shaft not to rotate and the other one of the sun gears rotate freely to be connected by a gear ratio of 1 or less and a gear ratio of 1 or more, and couples the two sun gears to rotate all together or couples one of the sun gear and the carrier to rotate all together and concurrently rotates the other one of the sun gears freely to ensure a 1:1 connection and provides a gear ratio of stage 3 between the input carrier and the output carrier of the pair of epicyclic gears.

4. The multistage transmission according to claim 3, wherein one of the carriers of the pair of epicyclic gears is coupled to a third epicyclic gear, ensures a gear ratio of stage 2 of a direction connection with one of a gear ratio of 1 or less and a gear ratio of 1 or more to provide a gear ratio of stage 6 between the input member and the output member.

5. The multistage transmission according to claim 1, wherein the epicyclic gear set has four pairs of epicyclic gears arranged in parallel to the center shaft to rotate, couples a pair of epicyclic gears in a center to respective carriers not to rotate and has two pairs of epicyclic gears in an outside form a pair of epicyclic gears, respectively to provide a gear ratio of stage 9 between the input member and the output member.

6. The multistage transmission according to claim 5, wherein each of the pair of epicyclic gears couples one of the two sun gears to the center shaft not to rotate and rotates the other one of the two sun gears freely to connect a gear ratio of 1 or less and a gear ratio of 1 or more, couples the two sun gears to rotate all together or couples one of the sun gears and the carrier to rotate all together and concurrently rotates the other one of the sun gears for 1:1 connection and selects a gear ratio of stage 3 to provide a gear ratio of stage 9 by a combination of the two pairs of epicyclic gears.

7. The multistage transmission according to claim 5, wherein one of the outside carriers of the pair of epicyclic gears is coupled to a fifth epicyclic gear, and ensures a gear ratio of stage 2 of a direction connection with one of a gear ratio of 1 or less and a gear ratio of 1 or more to provide a gear ratio of stage 18 between the input member and the output member.

8. The multistage transmission according to claim 1, wherein the transmission shaft comprises a hollow portion which surrounds the center shaft and rotates, a plurality of radial through holes in an external circumference, is involved in the operation of the clutch assembly through the through holes and is controlled by the outside of the hub.

9. The multistage transmission according to claim 1, wherein the transmission shaft provides a cam which is accommodated by the hollow portion of the center shaft in an axial direction and is involved in the operation of the clutch assembly through the radial through hole formed in the center shaft, and is controlled by the outside of the hub.

10. The multistage transmission according to claim 9, wherein the epicyclic gear set has a pair of epicyclic gears arranged in parallel in the center shaft within the hub to rotate, and has one of two sun gears of the pair of the epicyclic gears coupled to the center shaft not to rotate and the other one of the sun gears rotate freely to be connected by a gear ratio of 1 or less and a gear ratio of 1 or more, and couples the two sun gears to rotate all together or couples one of the sun gear and the carrier to rotate all together and concurrently rotates the other one of the sun gears freely to ensure a 1:1 connection and provides a gear ratio of stage 12 between the input member and the output member by forming a gear ratio of stage 2 and one of a gear ratio of 1 or less and a gear ratio of 1 or more and a gear ratio of stage 2 of direct connection.

11. The multistage transmission according to claim 1, wherein the multistage transmission is designed as a transmission with stage 3, stage 6, stage 9 or stage 12 and a gear ratio of the transmission is selected by one rotation of the transmission shaft.

12. The multistage transmission according to claim 1, wherein the multistage transmission is designed as a transmission with stage 6, stage 12, or stage 18 and a gear ratio of the transmission is selected by two-rotation guide groove of the center shaft and two rotation of the transmission shaft.

13. The multistage transmission according to claim 1, wherein the epicyclic gear of the epicyclic gear set comprises at least one of a sun gear, an epicyclic gear and a ring gear with different specifications.

14. The multistage transmission according to claim 1, wherein the epicyclic gear of the pair of epicyclic gears comprises a sun gear, a pinion and a ring gear with the same specifications.

15. The multistage transmission according to claim 1, wherein one of the ring gears of the pair of epicyclic gears surrounds the other one of the ring gears and is coupled to one of the carriers.

16. The multistage transmission according to claim 15, wherein a ring gear adapter which is coupled to one of the ring gears not to rotate, and a carrier adapter which is coupled to the other one of the carriers not to rotate surround one of the ring gears not to rotate relatively.

17. The multistage transmission according to claim 4, wherein the epicyclic gear which is coupled to have the gear ratio of stage 2 has one of the sun gear, carrier and ring gear of the epicyclic gear coupled to the carrier of the pair of epicyclic gear, and has one of the sun gear and carrier of the epicyclic gear coupled to the center shaft not to rotate to provide a gear ratio of 1 or less or a gear ratio of 1 or more among the gear ratio of stage 2, and has the sun gear and the carrier coupled to each other not to rotate relatively and provides a direct-connection gear ratio among the gear ratio of stage 2.

18. The multistage transmission according to claim 1, wherein the hub is coupled to the output member of the multistage transmission not to rotate.

19. The multistage transmission according to claim 1, further comprising a rotation shaft which is rotatably installed by passing through the center shaft in an axial direction, and a gear, chain or a similar link which connects the rotation shaft to rotate together with the input member.

20. The multistage transmission according to claim 1, further comprising a rotation shaft which is rotatably installed in the frame and a gear, chain or a similar link which connects the rotation shaft to rotate together with the input member.

21. The multistage transmission according to claim 19, wherein the hub comprises a housing that surrounds the input member and the output member to rotate and is fixed to the frame and further comprises a bracket to fix the center shaft to the frame.

22. The multistage transmission according to claim 21, wherein the hub further comprises a bevel gear mounted in the output side and a pinion gear which is supported by the housing and rotates by being engaged with the bevel gear.

23. The multistage transmission according to claim 22, wherein the pinion gear is coupled to the output side to transmit the rotational force of the output side to the outside, and further comprises a hollow tube which is coupled to the housing and supports and surrounds the pinion gear and the output side.
